(19) United States
(12) Patent Application Publication
(10) Pub. No.: US 2018/0342798 A1
(43) Pub. Date: Nov. 29, 2018

(54) FM ANTENNA, NFC ANTENNA, MULTI-FUNCTION ANTENNA AND LIGHTING APPARATUS

(71) Applicant: ZHEJIANG SHENGHUI LIGHTING CO., LTD., Jiaxing (CN)

(72) Inventors: Xinwang LIN, Jiaxing (CN); Jinxiang SHEN, Jiaxing (CN)

(21) Appl. No.: 15/777,107

(22) PCT Filed: Jul. 14, 2017
(86) PCT No.: PCT/CN2017/092908

§ 371 Date: May 17, 2018

(30) Foreign Application Priority Data
Jul. 14, 2016 (CN) 201610559151.X

(51) Int. Cl. H01Q 1/44; H01Q 21/30; H01Q 1/22; H04B 5/00

(52) U.S. Cl. CPC H01Q 1/44; H04B 5/00; H01Q 1/22; H01Q 21/30

(57) ABSTRACT

A frequency modulation (FM) antenna, a near field communication (NFC) antenna, a multi-function antenna, and a lighting apparatus are provided. A frequency modulation antenna, including a transformer having a secondary coil; a first high-pass filter; a first antenna matching network; and a frequency modulation circuit. The secondary coil of the transformer includes an output terminal connected to a first terminal of the first high-pass filter, a second terminal of the first high-pass filter is connected to the first antenna matching network, and the first antenna matching network is connected to the frequency modulation circuit.

### CROSS-REFERENCES TO RELATED APPLICATIONS

This application is a national phase entry under 35 U.S.C. § 371 of International Application No. PCT/CN2017/092908, filed on Jul. 14, 2017, which claims priority of Chinese Patent Application No. 201610559151.X, filed on Jul. 14, 2016, the entire content of which is incorporated by reference herein.

### TECHNICAL FIELD

The present disclosure generally relates to the field of internet of things and, more particularly, relates to a frequency modulation (FM) antenna, a near field communication (NFC) antenna, a multi-function antenna, and a lighting apparatus.

### BACKGROUND

With the development of smart home technology, a single indoor appliance may have a variety of functions. For example, a lighting apparatus can have an function to play music. In some existing techniques, in order to enable an indoor appliance to receive signals and perform related functions, an increased internal space of the indoor appliance is required to install an antenna for receiving the signals.

Generally, the antenna needs a sufficient length to ensure the quality of the received signals. Therefore, the existing techniques need to increase the internal space of the indoor appliance to install the antenna, which may also increase the cost of the indoor appliance.

Accordingly, it is desirable to provide an FM antenna, an NFC antenna, a multi-function antenna, and a lighting apparatus.

### BRIEF SUMMARY

In accordance with embodiments of the present disclosure, an FM antenna, an NFC antenna, a multi-function antenna, and a lighting apparatus are provided.

An aspect of the present disclosure provides a frequency modulation antenna, comprising: a transformer having a secondary coil; a first high-pass filter; a first antenna matching network; and a frequency modulation circuit. The secondary coil of the transformer includes an output terminal connected to a first terminal of the first high-pass filter, a second terminal of the first high-pass filter is connected to the first antenna matching network, and the first antenna matching network is connected to the frequency modulation circuit.

Further, the first high-pass filter includes a first inductor, a second inductor, a third inductor, a fourth inductor, a first capacitor, a second capacitor, and a third capacitor; the first inductor, the second inductor, the third inductor, and the fourth inductor are connected in parallel with the output terminal of the secondary coil and the first antenna matching network. The first capacitor, the second capacitor, and the third capacitor are connected in series with the output terminal of the secondary coil and the first antenna matching network.

Further, the first antenna matching network tunes a resonant frequency of the frequency modulation antenna, and the first antenna matching network is a π-type matching network.

Further, the first antenna matching network includes a fifth inductor, a fourth capacitor, and a fifth capacitor; the fourth capacitor and the fifth capacitor are connected in parallel with the output terminal of the first high-pass filter and the frequency modulation circuit; and the fifth inductor is connected in series with the output terminal of the first high-pass filter and the frequency modulation circuit.

Further, a first low pass filter including three capacitors connected in parallel and two inductors connected in series; a rectifier circuit and a filter circuit. The output terminal of the secondary coil is connected to a first terminal of the first low-pass filter, a second terminal of the first low-pass filter is connected to the rectifier circuit or the filter circuit.

Another aspect of the present disclosure provides a near field communication antenna, comprising: a transformer having a secondary coil; a second high-pass filter; a second antenna matching network; and a near field communication circuit. The secondary coil of the transformer includes an output terminal connected to a first terminal of the second high-pass filter, a second terminal of the second high-pass filter is connected to the second antenna matching network, and the second antenna matching network is connected to the near field communication circuit.

Further, the second high-pass filter includes a sixth inductor, a seventh inductor, an eighth inductor, a ninth inductor, a sixth capacitor, a seventh capacitor, and an eighth capacitor; the sixth inductor, the seventh inductor, the eighth inductor, and the ninth inductor are connected in parallel with the output terminal of the secondary coil and the second antenna matching network; and the sixth capacitor, the seventh capacitor, and the eighth capacitor are connected in series with the output terminal of the secondary coil and the second antenna matching network.

Further, the second antenna matching network tunes a resonant frequency of the near field communication antenna.

Further, the second antenna matching network is a π-type matching network.

Further, the second antenna matching network includes a tenth inductor, a ninth capacitor, and a tenth capacitor; the ninth capacitor and the tenth capacitor are connected in parallel with the output terminal of the second high-pass filter and the near field communication circuit; and the tenth inductor is connected in series with the output terminal of the first high-pass filter and the near field communication circuit.

Further, a first low pass filter including three capacitors connected in parallel and two inductors connected in series; a rectifier circuit; and a filter circuit. The output terminal of the secondary coil is connected to a first terminal of the first low-pass filter, a second terminal of the first low-pass filter is connected to the rectifier circuit or the filter circuit.

Another aspect of the present disclosure provides a multi-function antenna, comprising: a transformer having a secondary coil; a first high-pass filter second high-pass filter; a first antenna matching network and a second antenna matching network; a frequency modulation circuit; and a near field communication circuit. The secondary coil of the transformer includes an output terminal connected to a first terminal of the first high-pass filter and a first terminal of the second high-pass filter, a second terminal of the first high-pass filter is connected to the first antenna matching network, and the first antenna matching network is connected to the frequency modulation circuit, a second terminal of the second high-pass filter is connected to the second antenna matching network, and the second antenna matching network is connected to the near field communication circuit.

Further, the second high-pass filter includes a sixth inductor, a seventh inductor, an eighth inductor, a ninth inductor, a sixth capacitor, a seventh capacitor, and an eighth capacitor; the sixth inductor, the seventh inductor, the eighth inductor, and the ninth inductor are connected in parallel with the output terminal of the secondary coil and the second antenna matching network; and the sixth capacitor, the seventh capacitor, and the eighth capacitor are connected in series with the output terminal of the secondary coil and the second antenna matching network.

Further, the second antenna matching network is a π-type matching network for tuning a resonant frequency of the near field communication antenna.

Further, the first antenna matching network includes a fifth inductor, a fourth capacitor, and a fifth capacitor; the fourth capacitor and the fifth capacitor are connected in parallel with the output terminal of the first high-pass filter and the frequency modulation circuit; the fifth inductor is connected in series with the output terminal of the first high-pass filter and the frequency modulation circuit; the second antenna matching network includes a tenth inductor, a ninth capacitor, and a tenth capacitor; the ninth capacitor and the tenth capacitor are connected in parallel with the output terminal of the second high-pass filter and the near field communication circuit; and the tenth inductor is connected in series with the output terminal of the first high-pass filter and the near field communication circuit. A first low pass filter including three capacitors connected in parallel and two inductors connected in series, a rectifier circuit and a filter circuit. The output terminal of the secondary coil is connected to a first terminal of the first low-pass filter, a second terminal of the first low-pass filter is connected to the rectifier circuit or the filter circuit.

Another aspect of the present disclosure provides a lighting apparatus, comprising a frequency modulation antenna as described above.

Another aspect of the present disclosure provides a lighting apparatus, comprising a near field communication antenna as described above.

Another aspect of the present disclosure provides a lighting apparatus, comprising a multi-function antenna as described above.

Other aspects of the present disclosure can be understood by those skilled in the art in light of the description, the claims, and the drawings of the present disclosure.

### BRIEF DESCRIPTION OF THE DRAWINGS

Various objects, features, and advantages of the present disclosure can be more fully appreciated with reference to the following detailed description of the present disclosure when considered in connection with the following drawings, in which like reference numerals identify like elements. It should be noted that the following drawings are merely examples for illustrative purposes according to various disclosed embodiments and are not intended to limit the scope of the present disclosure.

FIG. 1 is a schematic structural diagram of an exemplary FM antenna in accordance with various embodiments of the present disclosure;

FIG. 2 is a schematic circuit diagram of an exemplary FM antenna in accordance with various embodiments of the present disclosure;

FIG. 3 is a schematic structural diagram of an exemplary NFC antenna in accordance with various embodiments of the present disclosure;

FIG. 4 is a schematic circuit diagram of an exemplary NFC antenna in accordance with various embodiments of the present disclosure;

FIG. 5 is a schematic structural diagram of an exemplary multi-function antenna in accordance with various embodiments of the present disclosure;

FIG. 6 is a schematic circuit diagram of an exemplary multi-function antenna in accordance with various embodiments of the present disclosure;

FIG. 7 is a schematic structural diagram of an exemplary lighting apparatus in accordance with various embodiments of the present disclosure;

FIG. 8 is a schematic structural diagram of another exemplary lighting apparatus in accordance with some other embodiments of the present disclosure; and

FIG. 9 is a schematic structural diagram of another exemplary lighting apparatus in accordance with some other embodiments of the present disclosure.

### DETAILED DESCRIPTION

For those skilled in the art to better understand the technical solution of the present disclosure, reference will now be made in detail to exemplary embodiments of the present disclosure, which are illustrated in the accompanying drawings. Wherever possible, the same reference numbers will be used throughout the drawings to refer to the same or like parts.

It should be noted that, the terms “first,” “second,” “third,” “fourth” and the like (if exist) in the specification and claims of the present disclosure and in the accompanying drawings are intended to distinguish between similar objects and not to describe specific order. That is, the terms may be interchangeable when appropriate, such that the described embodiments of the present disclosure can be implemented in any other suitable orders.

In addition, the terms “comprising,” “including,” having,” and any variations thereof are intended to cover a non-exclusive inclusion. For example, a process, a method, a system, a product or a device that includes a series of steps or units/components may also include any other suitable steps, units/components that are not clearly described, or are inherent to the process, method, system product, or device.

In accordance with various embodiments, the present disclosure provides an FM antenna, an NFC antenna, a multi-function antenna, and a lighting apparatus. The disclosed lighting apparatus does not require a large internal space to install the FM antenna, the NFC antenna, or the multi-function antenna. As such, the manufacturing cost of the lighting apparatus can be reduced.

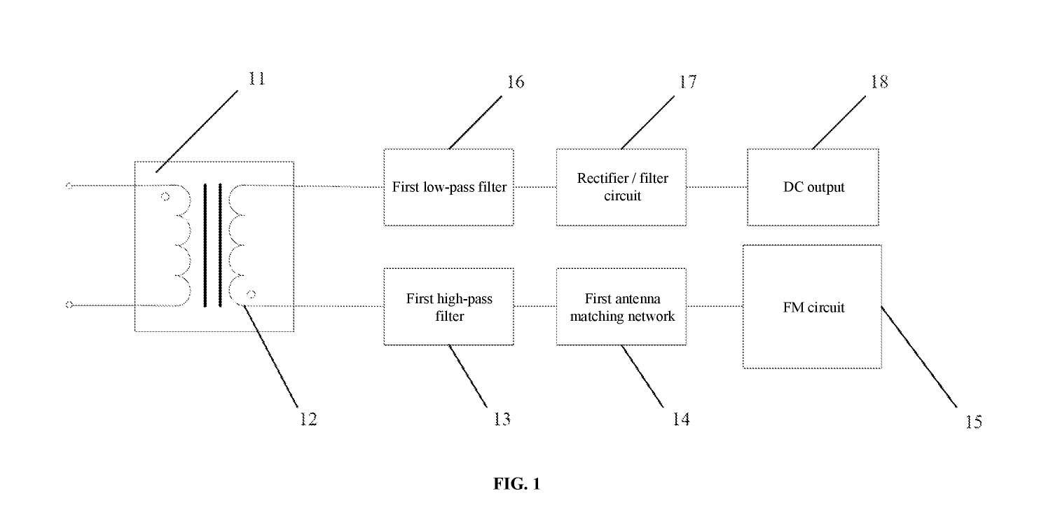

FIG. 1 is a schematic structural diagram of an exemplary FM antenna in accordance with various embodiments of the present disclosure.

As shown in FIG. 1, the FM antenna can include a transformer 11 having a primary coil (not numbered), a secondary coil 12, a first high-pass filter 13, a first antenna matching network 14, an FM circuit 15, a first low pass filter 16, and a rectifier/filter circuit 17.

In some embodiments, the secondary coil 12 of the transformer 11 can have an output terminal connected to a first terminal of the first high-pass filter 13. A second terminal of the first high-pass filter 13 can be connected to the first antenna matching network 14. The first antenna matching network can be connected to the FM circuit 15.

In some embodiments, the transformer 11 can be a necessary device in an alternating current (AC) to direct current (DC) circuit for changing the AC voltage by using of electromagnetic induction principle. The secondary coil 12 of the transformer 11 can be formed by a metal wire which has a desired length to meet the length required for the FM antenna.

The output terminal of the secondary coil 12 of the transformer 11 can be connected to the first terminal of the first high-pass filter 13. The first high-pass filter 13 can block the alternating current signal outputted from the secondary coil 12, and can conduct the alternating current signal directly to the reference ground. Further, the first high-pass filter 13 can pass the FM signal received by the secondary coil 12 to the first antenna matching network 14 through the second terminal of the first high-pass filter 13.

The first antenna matching network 14 can be used for tuning the resonant frequency of the FM antenna served by the secondary coil 12 to the frequency required for frequency modulation.

The FM circuit 15 can be used for processing the FM signal that is received by the secondary coil 12 and processed by the first high-pass filter 13 and the first antenna matching network 14.

In some embodiments, the output terminal of the secondary coil 12 can be further connected to a first terminal of the first low pass filter 16. The first low pass filter 16 can block the FM signal received by the secondary coil 12, and can transmit the alternating current signal of the secondary coil 12 into the rectifier/filter circuit 17 through the second terminal of the first low pass filter 16. The rectifying/filtering circuit 17 can process the alternating current signal to convert the alternating current signal into a direct current (DC) output 18.

As described above, the disclosed FM antenna can include a transformer having a secondary coil, a first high-pass filter, a first antenna matching network and an FM circuit. The secondary coil of the transformer has an output terminal connected to a first terminal of the first high-pass filter. A second terminal of the first high-pass filter is connected to the first antenna matching network. The first antenna matching network is connected to the FM circuit.

In the disclosed FM antenna, the secondary coil of the transformer can be used as the FM antenna. As such, no additional internal space of the electronic device is required for installing a special FM antenna, which can reduce the manufacturing cost of the electronic device. Further, since the FM antenna can be located inside the electronic device, the FM antenna may be not affected by the outside, thus the stability of the FM antenna can be improved.

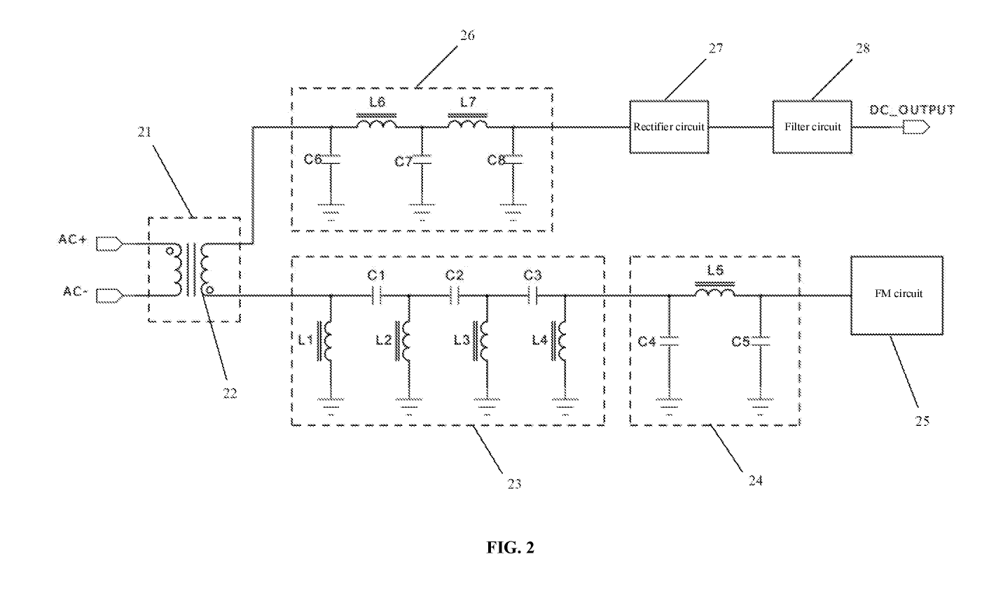

FIG. 2 is a schematic circuit diagram of an exemplary FM antenna in accordance with various embodiments of the present disclosure. Some implementations of the disclosed FM antenna described above in connection with FIG. 1 can be illustrated by FIG. 2.

As shown, AC+ and AC− indicate the public alternating current input, and DC_OUTPUT is the direct current output. The secondary coil 22 of the transformer 21, the first low-pass filter 26, the rectifier circuit 27, and the filter circuit 28 can constitute a conventional AC-DC circuit. The first high-pass filter 23, the first antenna matching network 24, and the FM circuit 25 can receive the FM signals.

In some embodiments, the first high-pass filter 23 can include a first inductor L1, a second inductor L2, a third inductor L3, a fourth inductor L4, a first capacitor C1, a second capacitor C2, and a third capacitor C3. The first inductor L1, the second inductor L2, the third inductor L3, the fourth inductor L4 can be connected in parallel with the output terminal of the secondary coil 22 and the first antenna matching network 24. The first capacitor C1, the second capacitor C2, and the third capacitor C3 can be connected in series with the output terminal of the secondary coil 22 and the first antenna matching network 24.

The AC voltage of the secondary coil 22 may be about 100V or above, thus the first inductor L1 and the first capacitor C1 can have a sufficient withstand voltage value. The sensitivity of the FM signals may be as low as −107 dBm (i.e., 1 uV), which is much lower than the AC voltage. Therefore, the first high-pass filter 23 can have a sufficient out-of-band rejection ratio, thereby preventing the interfering from the AC signals to the FM signals.

In some embodiments, the first antenna matching network can be a π-type matching network. The first antenna matching network can include a fifth inductor L5, a fourth capacitor C4, and a fifth capacitor C5. The fourth capacitor C4 and the fifth capacitor C5 can be connected in parallel with the output terminal of the first high-pass filter 23 and the FM circuit 25. The fifth inductor L5 can be connected in series with the output terminal of the first high-pass filter 23 and the FM circuit 25. In some other embodiments, the first antenna matching network 24 may be not limited to the π-type matching network, and can be configured to any suitable type of inductor-capacitor (LC) matching circuit according to the actual impedance matching.

In some embodiments, as shown in FIG. 2, the first low-pass filter 26 can include a capacitor C6, a capacitor C7, a capacitor C8, an inductor L6, and an inductor L7.

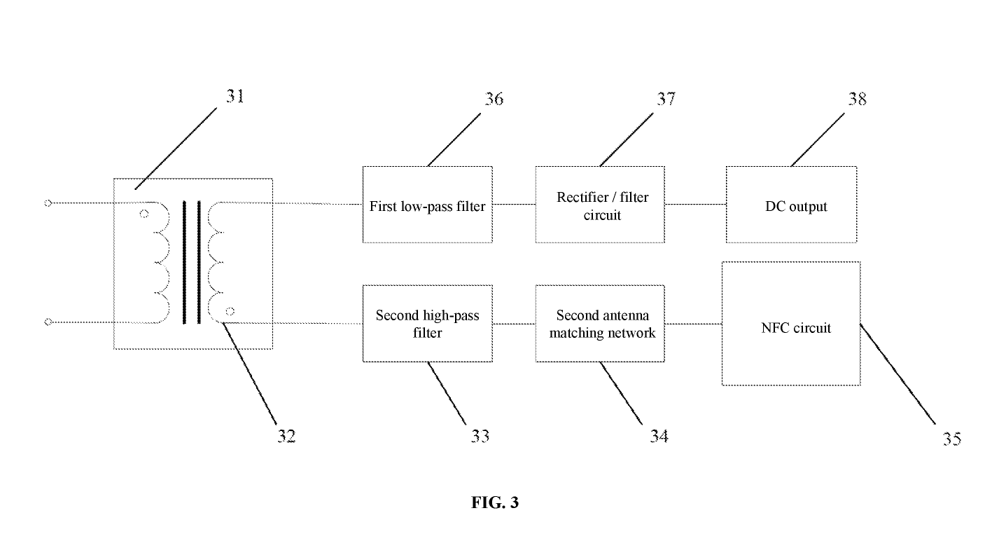

FIG. 3 is a schematic structural diagram of an exemplary NFC antenna in accordance with various embodiments of the present disclosure.

As shown in FIG. 3, the NFC antenna can include a transformer 31 having a secondary coil 32, a second high-pass filter 33, a second antenna matching network 34, an NFC circuit 35, a first low pass filter 36, and a rectifier/filter circuit 37.

In some embodiments, the secondary coil 32 of the transformer 31 can have an output terminal connected to a first terminal of the second high-pass filter 33. A second terminal of the second high-pass filter 33 can be connected to the second antenna matching network 34. The second antenna matching network can be connected to the NFC circuit 35.

In some embodiments, the transformer 31 can be a necessary device in an alternating current (AC) to direct current (DC) circuit for changing the AC voltage by using of electromagnetic induction principle. The secondary coil 32 of the transformer 31 can be formed by a metal wire which has a desired length to meet the length required for the NFC antenna.

The output terminal of the secondary coil 32 of the transformer 31 can be connected to the first terminal of the second high-pass filter 33. The second high-pass filter 33 can block the alternating current signal outputted from the secondary coil 32, and can conduct the alternating current signal directly to the reference ground. Further, the second high-pass filter 33 can pass the NFC signal received by the secondary coil 32 to the second antenna matching network 34 through the second terminal of the second high-pass filter 33.

The second antenna matching network 34 can be used for tuning the resonant frequency of the NFC antenna served by the secondary coil 32 to the frequency required for near field communication.

The NFC circuit 35 can be used for processing the NFC signal that is received by the secondary coil 32 and processed by the second high-pass filter 33 and the second antenna matching network 34.

In some embodiments, the output terminal of the secondary coil 32 can be further connected to a first terminal of the first low pass filter 36. The first low pass filter 36 can block the NFC signal received by the secondary coil 32, and can transmit the alternating current signal of the secondary coil 32 into the rectifier/filter circuit 37 through the second terminal of the first low pass filter 36. The rectifying/filtering circuit 37 can process the alternating current signal to convert the alternating current signal into a direct current (DC) output 38.

As described above, the disclosed NFC antenna can include a transformer having a secondary coil, a second high-pass filter, a second antenna matching network and an NFC circuit. The secondary coil of the transformer has an output terminal connected to a first terminal of the second high-pass filter. A second terminal of the second high-pass filter is connected to the second antenna matching network. The second antenna matching network is connected to the NFC circuit.

In the disclosed NFC antenna, the secondary coil of the transformer can be used as the NFC antenna. As such, no additional internal space of the electronic device is required for installing a special NFC antenna, which can reduce the manufacturing cost of the electronic device. Further, since the NFC antenna can be located inside the electronic device, the NFC antenna may be not affected by the outside, thus the stability of the NFC antenna can be improved.

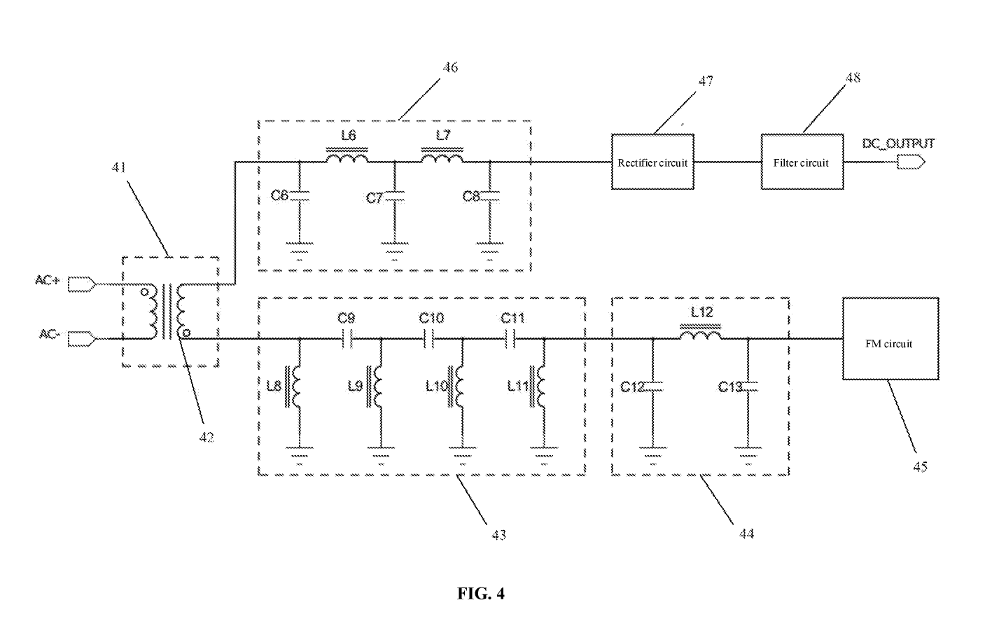

FIG. 4 is a schematic circuit diagram of an exemplary NFC antenna in accordance with various embodiments of the present disclosure. Some implementations of the disclosed NFC antenna described above in connection with FIG. 3 can be illustrated by FIG. 4.

As shown, AC+ and AC− indicate the public alternating current input, and DC_OUTPUT is the direct current output. The secondary coil 42 of the transformer 41, the first low-pass filter 46, the rectifier circuit 47, and the filter circuit 48 can constitute a conventional AC-DC circuit. The second high-pass filter 43, the second antenna matching network 44, and the NFC circuit 45 can transmit and receive the NFC signals.

In some embodiments, the second high-pass filter 43 can include a sixth inductor L8, a seventh inductor L9, an eighth inductor L10, a ninth inductor L11, a sixth capacitor C9, a seventh capacitor C10, and an eighth capacitor C11. The sixth inductor L8, the seventh inductor L9, the eighth inductor L10, and the ninth inductor L11 can be connected in parallel with the output terminal of the secondary coil 42 and the second antenna matching network 44. The sixth capacitor C9, the seventh capacitor C10, and the eighth capacitor C11 can be connected in series with the output terminal of the secondary coil 42 and the second antenna matching network 44.

The AC voltage of the secondary coil 42 may be about 100V or above, thus the sixth inductor L8 and the sixth capacitor C9 can have a sufficient withstand voltage value. The sensitivity of the NFC signals may be much lower than the AC voltage. Therefore, the second high-pass filter 43 can have a sufficient out-of-band rejection ratio, thereby preventing the interfering from the AC signals to the NFC signals.

In some embodiments, the second antenna matching network 44 can be a π-type matching network. The first antenna matching network can include a tenth inductor L12, a ninth capacitor C12, and a tenth capacitor C13. The ninth capacitor C12 and the tenth capacitor C13 can be connected in parallel with the output terminal of the second high-pass filter 43 and the NFC circuit 45. The tenth inductor L12 can be connected in series with the output terminal of the second high-pass filter 43 and the NFC circuit 45. In some other embodiments, the second antenna matching network 44 may be not limited to the π-type matching network, and can be configured to any suitable type of inductor-capacitor (LC) matching circuit according to the actual impedance matching.

In some embodiments, as shown in FIG. 4, the first low-pass filter 26 can include a capacitor C6, a capacitor C7, a capacitor C8, an inductor L6, and an inductor L7.

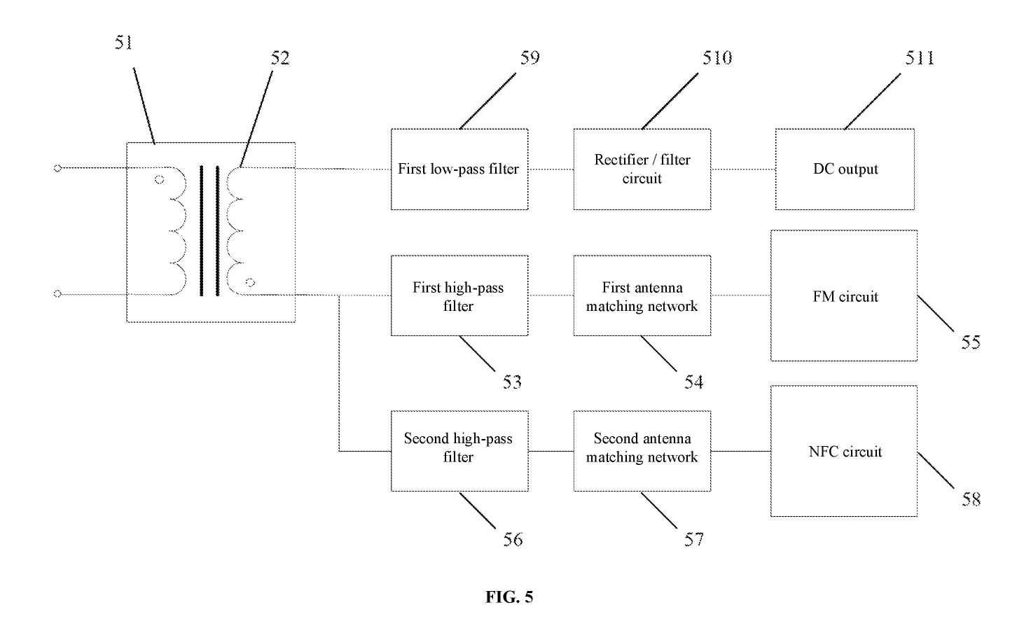

FIG. 5 is a schematic structural diagram of an exemplary multi-function antenna in accordance with various embodiments of the present disclosure.

As shown in FIG. 5, the multi-function antenna can include a transformer 51 having a secondary coil 52, a first high-pass filter 53, a first antenna matching network 54, an FM circuit 55, a second high-pass filter 55, a second antenna matching network 57, an NFC circuit 58, a first low pass filter 59, and a rectifier/filter circuit 510.

In some embodiments, the secondary coil 52 of the transformer 51 can have an output terminal connected to a first terminal of the first high-pass filter 53 and a first terminal of the second high-pass filter 56. A second terminal of the first high-pass filter 53 can be connected to the first antenna matching network 54. The first antenna matching network can be connected to the FM circuit 55. A second terminal of the second high-pass filter 56 can be connected to the second antenna matching network 57. The second antenna matching network can be connected to the NFC circuit 58.

The first high-pass filter 53, the first antenna matching network 54, and the FM circuit 55 can receive the FM signal. The second high-pass filter 56, the second antenna matching network 57, and the NFC circuit 58 transmit and receive NFC signals. As such, in the disclosed multi-function antenna, the FM antenna and NFC antenna can share a common transformer.

The connection relationship of different components of the multi-function antenna as shown in FIG. 5 can be referred to the embodiments described above in connection with FIG. 2 and FIG. 4, and is not repeated here.

In some embodiments, the output terminal of the secondary coil 52 can be further connected to a first terminal of the first low pass filter 59. The first low pass filter 59 can transmit the alternating current signal of the secondary coil 52 into the rectifier/filter circuit 510 through the second terminal of the first low pass filter 59. The rectifying/filtering circuit 510 can process the alternating current signal to convert the alternating current signal into a direct current (DC) output 511.

FIG. 6 is a schematic circuit diagram of an exemplary multi-function antenna in accordance with various embodiments of the present disclosure. Some implementations of the disclosed multi-function antenna described above in connection with FIG. 5 can be illustrated by FIG. 6.

As shown, AC+ and AC− indicate the public alternating current input, and DC_OUTPUT is the direct current output. The secondary coil 62 of the transformer 61, the first low-pass filter 69, the rectifier circuit 510, and the filter circuit 611 can constitute a conventional AC-DC circuit. The first high-pass filter 63, the first antenna matching network 64, and the FM circuit 65 can receive the FM signals. The second high-pass filter 66, the second antenna matching network 67, and the NFC circuit 68 transmit and receive NFC signals. As such, in the disclosed multi-function antenna, the FM antenna and NFC antenna can share a common transformer.

The specific circuit implementations of the first high-pass filter 63, the first antenna matching network 64, the second high-pass filter 66, the second antenna matching network 67 and the first low-pass filter 69 can be referred to the embodiments described above in connection with FIG. 2 and FIG. 4, and are not repeated here.

In some embodiments, the multi-function antenna can further include a radio frequency (RF) switch. The RF switch can include a fixed terminal and a selection terminal. The selection terminal can include a first selection terminal and a second selection terminal. By operating the RF switch, the fixed terminal can be connected to either the first selection terminal or the sectional terminal.

For example, as shown in FIG. 6, the fixed terminal of the RF switch 613 can be connected to the output terminal of the secondary coil 62. The first selection terminal of the RF switch 613 can be connected to the first terminal of the first high-pass filter 63. The second selection terminal of the RF switch 613 can be connected to the first terminal of the second high-pass filter 66.

The circuit of the third high-pass filter 612 can include an inductor L13 and a capacitor C14. The third high pass filter 612 can be used to transmit the alternating current signal of the secondary coil 62 to the reference ground. As such, the potential damage from the alternating current signal to the RF switch 613 can be prevented.

The RF switch 613 can select receiving the FM signals by using the first high-pass filter 63, the first antenna matching network 64 and the FM circuit 65, or transmitting and receiving the NFC signals by using the second high-pass filter 66, the second antenna matching network, and the NFC circuit 68.

In some embodiments, the control instructions GPIO1 and GPIO2 of the RF switch 613 to switch between the selection terminals can be generated by a system master chip. For example, Table 1 shows a logic table of the RF switch.

TABLE 1

| GPIO1 | GPIO2 | OUT_IN1 | OUT-IN2 |
|---|---|---|---|
| High level | Low level | Connected | Disconnected |
| Low level | High level | Disconnected | Connected |

As shown in Table 1, when GPIO1 is at high level and GPIO2 is at low level, the fixed terminal OUT is connected with the first selection terminal IN1, and the fixed terminal OUT is disconnected with the second selection terminal IN2. When GPIO1 is at low level and GPIO2 is at high level, the fixed terminal OUT is disconnected with the first selection terminal IN1, and the fixed terminal OUT is connected with the second selection terminal IN2.

As described above, the disclosed multi-function antenna can include a transformer having a secondary coil, a first high-pass filter, a first antenna matching network, an FM circuit, a second high-pass filter, a second antenna matching network, and an NFC circuit. The secondary coil of the transformer has an output terminal connected to a first terminal of the first high-pass filter and a first terminal of the second high-pass filter. A second terminal of the first high-pass filter is connected to the first antenna matching network. The first antenna matching network is connected to the FM circuit. A second terminal of the second high-pass filter is connected to the second antenna matching network. The second antenna matching network is connected to the NFC circuit.

In the disclosed multi-function antenna, the secondary coil of the transformer can be used as the antenna. Further, an RF switch is used to select the different functions of different antennas. As such, no additional internal space of the electronic device is required for installing special antennas, which can reduce the manufacturing cost of the electronic device. Further, since the antennas can be located inside the electronic device, the antennas may be less affected by the outside environment, thus the stability of the multi-function antenna can be improved.

It should be noted that, FIGS. 2, 4, and 6 are only examples of a high-pass filter, a low-pass filter, an RF switch, and an antenna matching network topology. In the antenna design according to the figures, the configuration can be adjusted based on the actual situation of the transformer circuit. Further, the implementations of the rectifier circuit and the filter circuit that are not described are well known to those skilled in the art.

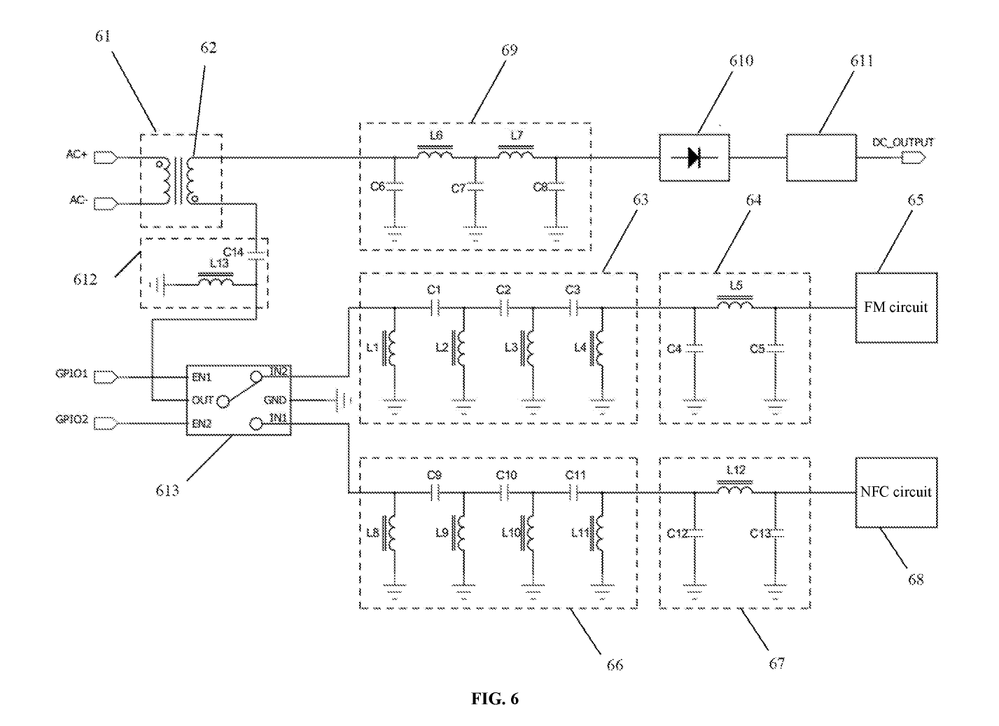

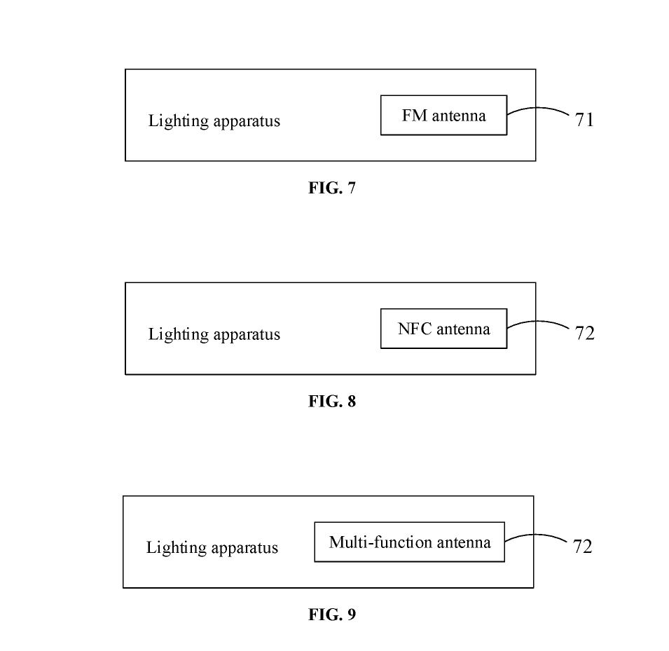

FIG. 7 is a schematic structural diagram of an exemplary lighting apparatus in accordance with various embodiments of the present disclosure.

As shown, the lighting apparatus can include an FM antenna 71. In some embodiments, the FM antenna 71 may be the FM antenna described above in connection with FIG. 1.

The disclosed FM antenna can include a transformer having a secondary coil, a first high-pass filter, a first antenna matching network, and an FM circuit. The secondary coil of the transformer has an output terminal connected to a first terminal of the first high-pass filter. A second terminal of the first high-pass filter is connected to the first antenna matching network. The first antenna matching network is connected to the FM circuit.

In the disclosed FM antenna, the secondary coil of the transformer can be used as the FM antenna. As such, no additional internal space of the electronic device is required for installing a special FM antenna, which can reduce the manufacturing cost of the electronic device. Further, since the FM antenna can be located inside the electronic device, the FM antenna may be not affected by the outside, thus the stability of the FM antenna can be improved.

FIG. 8 is a schematic structural diagram of another exemplary lighting apparatus in accordance with some other embodiments of the present disclosure.

As shown, the lighting apparatus can include an NFC antenna 81. In some embodiments, the NFC antenna 81 may be referred to the NFC antenna described above in connection with FIG. 3.

The disclosed NFC antenna can include a transformer having a secondary coil, a second high-pass filter, a second antenna matching network, and an NFC circuit. The secondary coil of the transformer has an output terminal connected to a first terminal of the second high-pass filter. A second terminal of the second high-pass filter is connected to the second antenna matching network. The second antenna matching network is connected to the NFC circuit.

In the disclosed NFC antenna, the secondary coil of the transformer can be used as the NFC antenna. As such, no additional internal space of the electronic device is required for installing a special NFC antenna, which can reduce the manufacturing cost of the electronic device. Further, since the NFC antenna can be located inside the electronic device, the NFC antenna may be not affected by the outside, thus the stability of the NFC antenna can be improved.

FIG. 9 is a schematic structural diagram of another exemplary lighting apparatus in accordance with some other embodiments of the present disclosure. As shown, the lighting apparatus can include a multi-function antenna 91. In some embodiments, the multi-function antenna 91 may be referred to the multi-function antenna described above in connection with FIG. 5.

The disclosed multi-function antenna can include a transformer having a secondary coil, a first high-pass filter, a first antenna matching network, an FM circuit, a second high-pass filter, a second antenna matching network, and an NFC circuit. The secondary coil of the transformer has an output terminal connected to a first terminal of the first high-pass filter and a first terminal of the second high-pass filter. A second terminal of the first high-pass filter is connected to the first antenna matching network. The first antenna matching network is connected to the FM circuit. A second terminal of the second high-pass filter is connected to the second antenna matching network. The second antenna matching network is connected to the NFC circuit.

In the disclosed multi-function antenna, the secondary coil of the transformer can be used as the antenna. Further, an RF switch is used to select the different functions of different antennas. As such, no additional internal space of the electronic device is required for installing special antennas, which can reduce the manufacturing cost of the electronic device. Further, since the antennas can be located inside the electronic device, the antennas may be less affected by the outside environment, thus the stability of the multi-function antenna can be improved.

Accordingly, an FM antenna, an NFC antenna, a multi-function antenna, and a lighting apparatus are provided.

The descriptions of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Although the present disclosure has been described and illustrated in the foregoing illustrative embodiments, it is understood that the present disclosure has been made only by way of example, and that numerous changes in the details of embodiment of the present disclosure can be made without departing from the spirit and scope of the present disclosure, which is only limited by the claims which follow. Features of the disclosed embodiments can be combined and rearranged in various ways. Without departing from the spirit and scope of the present disclosure, modifications, equivalents, or improvements to the present disclosure are understandable to those skilled in the art and are intended to be encompassed within the scope of the present disclosure.

What is claimed is:

1. A frequency modulation antenna, comprising:
a transformer having a secondary coil;
a first high-pass filter;
a first antenna matching network; and
a frequency modulation circuit,
wherein the secondary coil of the transformer includes an output terminal connected to a first terminal of the first high-pass filter, a second terminal of the first high-pass filter is connected to the first antenna matching network, and the first antenna matching network is connected to the frequency modulation circuit.

2. The frequency modulation antenna of claim 1, wherein:
the first high-pass filter includes a first inductor, a second inductor, a third inductor, a fourth inductor, a first capacitor, a second capacitor, and a third capacitor;
the first inductor, the second inductor, the third inductor, and the fourth inductor are connected in parallel with the output terminal of the secondary coil and the first antenna matching network; and
the first capacitor, the second capacitor, and the third capacitor are connected in series with the output terminal of the secondary coil and the first antenna matching network.

3. The frequency modulation antenna of claim 1, wherein:
the first antenna matching network tunes a resonant frequency of the frequency modulation antenna.

4. The frequency modulation antenna of claim 1, wherein:
the first antenna matching network is a π-type matching network.

5. The frequency modulation antenna of claim 1, wherein:
the first antenna matching network includes a fifth inductor, a fourth capacitor, and a fifth capacitor;
the fourth capacitor and the fifth capacitor are connected in parallel with the output terminal of the first high-pass filter and the frequency modulation circuit; and
the fifth inductor is connected in series with the output terminal of the first high-pass filter and the frequency modulation circuit.

6. The frequency modulation antenna of claim 1, further comprising:
a first low pass filter including three capacitors connected in parallel and two inductors connected in series;
a rectifier circuit; and
a filter circuit,
wherein the output terminal of the secondary coil is connected to a first terminal of the first low-pass filter, a second terminal of the first low-pass filter is connected to the rectifier circuit or the filter circuit.

7. A near field communication antenna, comprising:
a transformer having a secondary coil;
a second high-pass filter;
a second antenna matching network; and
a near field communication circuit,
wherein the secondary coil of the transformer includes an output terminal connected to a first terminal of the second high-pass filter, a second terminal of the second high-pass filter is connected to the second antenna matching network, and the second antenna matching network is connected to the near field communication circuit.

8. The near field communication antenna of claim 7, wherein:
the second high-pass filter includes a sixth inductor, a seventh inductor, an eighth inductor, a ninth inductor, a sixth capacitor, a seventh capacitor, and an eighth capacitor;
the sixth inductor, the seventh inductor, the eighth inductor, and the ninth inductor are connected in parallel with the output terminal of the secondary coil and the second antenna matching network; and
the sixth capacitor, the seventh capacitor, and the eighth capacitor are connected in series with the output terminal of the secondary coil and the second antenna matching network.

9. The near field communication antenna of claim 7, wherein:
the second antenna matching network tunes a resonant frequency of the near field communication antenna.

10. The near field communication antenna of claim 7, wherein:
the second antenna matching network is a π-type matching network.

11. The near field communication antenna of claim 7, wherein:
the second antenna matching network includes a tenth inductor, a ninth capacitor, and a tenth capacitor;
the ninth capacitor and the tenth capacitor are connected in parallel with the output terminal of the second high-pass filter and the near field communication circuit; and
the tenth inductor is connected in series with the output terminal of the first high-pass filter and the near field communication circuit.

12. The near field communication antenna of claim 7, further comprising:
a first low pass filter including three capacitors connected in parallel and two inductors connected in series;
a rectifier circuit; and
a filter circuit,
wherein the output terminal of the secondary coil is connected to a first terminal of the first low-pass filter, a second terminal of the first low-pass filter is connected to the rectifier circuit or the filter circuit.

13. A multi-function antenna, comprising:
a transformer having a secondary coil;
a first high-pass filter and a second high-pass filter;
a first antenna matching network and a second antenna matching network;
a frequency modulation circuit; and
a near field communication circuit,
wherein the secondary coil of the transformer includes an output terminal connected to a first terminal of the first high-pass filter and a first terminal of the second high-pass filter, a second terminal of the first high-pass filter is connected to the first antenna matching network, and the first antenna matching network is connected to the frequency modulation circuit, a second terminal of the second high-pass filter is connected to the second antenna matching network, and the second antenna matching network is connected to the near field communication circuit.

14. The multi-function antenna of claim 13, wherein:
the second high-pass filter includes a sixth inductor, a seventh inductor, an eighth inductor, a ninth inductor, a sixth capacitor, a seventh capacitor, and an eighth capacitor;
the sixth inductor, the seventh inductor, the eighth inductor, and the ninth inductor are connected in parallel with the output terminal of the secondary coil and the second antenna matching network; and
the sixth capacitor, the seventh capacitor, and the eighth capacitor are connected in series with the output terminal of the secondary coil and the second antenna matching network.

15. The multi-function antenna of claim 13, wherein:
the second antenna matching network is a π-type matching network for tuning a resonant frequency of the near field communication antenna.

16. The multi-function antenna of claim 13, wherein:
the first antenna matching network includes a fifth inductor, a fourth capacitor, and a fifth capacitor;
the fourth capacitor and the fifth capacitor are connected in parallel with the output terminal of the first high-pass filter and the frequency modulation circuit;
the fifth inductor is connected in series with the output terminal of the first high-pass filter and the frequency modulation circuit;
the second antenna matching network includes a tenth inductor, a ninth capacitor, and a tenth capacitor;
the ninth capacitor and the tenth capacitor are connected in parallel with the output terminal of the second high-pass filter and the near field communication circuit; and
the tenth inductor is connected in series with the output terminal of the first high-pass filter and the near field communication circuit.

17. The multi-function antenna of claim 13, further comprising:
a first low pass filter including three capacitors connected in parallel and two inductors connected in series;
a rectifier circuit; and
a filter circuit,
wherein the output terminal of the secondary coil is connected to a first terminal of the first low-pass filter, a second terminal of the first low-pass filter is connected to the rectifier circuit or the filter circuit.

18. The multi-function antenna of claim 13, further comprising:
an RF switch, a fixed terminal of the RF switch being connected to the output terminal of the secondary coil, a first selection terminal of the RF switch being connected to the first terminal of the first high-pass filter, and a second selection terminal of the RF switch being connected to the first terminal of the second high-pass filter.

19. The multi-function antenna of claim 18, further comprising:
a third high-pass filter transmitting an alternating current signal of the secondary coil to a reference ground.

20. A lighting apparatus, comprising a multi-function antenna according to claim 13.
